(19) United States
(12) Patent Application Publication
(10) Pub. No.: US 2009/0165479 A1
(43) Pub. Date: Jul. 2, 2009

(54) SOLAR POWERED VENTILATION SYSTEM FOR AUTOMOBILE

(76) Inventors: Kuo-Len LIN, Wugu Township (TW); Tien-Chih Tseng, Wugu Township (TW); Wen-Jung Liu, Wugu Township (TW); Hai-Rui Ye, Wugu Township (TW)

Correspondence Address: HDLS Patent & Trademark Services, P.O. BOX 220746, CHANTILLY, VA, 20153-0746, US

(21) Appl. No.: 12/397,644

(22) Filed: Mar. 4, 2009

Related U.S. Application Data
(63) Continuation-in-part of application No. 11/538,106, filed on Oct. 3, 2006.

(51) Int. Cl. B60H 1/00

(52) U.S. Cl. 62/132; 62/235.1

(57) ABSTRACT

A solar powered ventilation system using a blower of an air conditioner in an automobile is disclosed. The blower is driven by a solar generator mounted on a roof of the automobile. A relay is arranged between the solar generator and the blower for switching on/off. The relay is controlled by a controller. A thermosensor is connected to the controller for detecting inside temperature of the automobile. The controller controls the relay to switch on and controls the air conditioner into an external circulation mode when the automobile is choked and the inside temperature exceeds a threshold temperature.

This patent application is a continuation-in-part of U.S. patent application Ser. No. 11/538,106, filed Oct. 3, 2006.

### BACKGROUND OF THE INVENTION

1. Field of the Invention

The invention relates solar power generation systems used in vehicles, particularly to solar powered ventilation systems of automobiles.

2. Description of Related Art

Cars are usually parked in an open-air parking lot. In the summer, interior temperature of parked cars always rises above 50° C. The reason why the interior temperature rises is that the windows are closed so that interior air can not make convection with exterior air. It is very uncomfortable to a driver or passenger when he or she initially gets in a parked car. Although an air-conditioner of car lower the interior temperature after engine has been started, it still needs a period of time.

To solve this problem, some experienced drivers slightly open car windows to keep a gap for air convection. However, this knack can not be used in rainy or windy days. Further, its cooling effect is not good enough.

Some products of solar powered ventilating fan are provided in the market. Those solar fans are installed on an upper edge of window of a car door. The fan is driven by a solar cell. However, such products still can not provide great result because the solar cell fixedly attached inside the glass is hard to be directly shined by the sun and the sunshine must be attenuated by the heat insulation glass.

### SUMMARY OF THE INVENTION

An object of the invention is to provide a solar powered ventilation system for a automobile, which makes a blower of an air conditioner driven by solar power operate in an external circulation mode to improve the air convection in a parked vehicle.

To accomplish the above objective, the solar powered ventilation system for an automobile comprises a solar generator, a relay, a controller and a thermosensor. The blower is driven by the solar generator mounted on a roof of the automobile. The relay is arranged between the solar generator and the blower for switching on/off. The relay is controlled by the controller. The thermosensor is connected to the controller for detecting inside temperature of the automobile. The controller controls the relay to switch on and controls the air conditioner into an external circulation mode when the automobile is choked and the inside temperature exceeds a threshold temperature.

### BRIEF DESCRIPTION OF THE DRAWINGS

FIG. 1 is a block diagram of a preferred embodiment according to the invention.

### DETAILED DESCRIPTION OF THE INVENTION

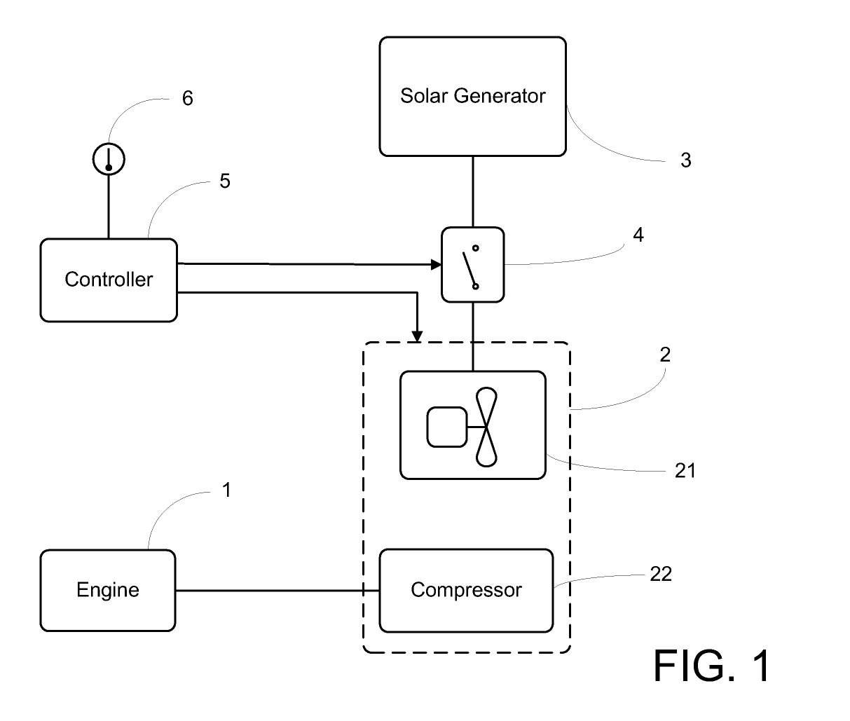

Referring to FIG. 1, the system according to the invention is used in a automobile powered by an engine 1. The automobile has a built-in air conditioner 2 composed of a blower 21 and a compressor 22 clutchedly driven by the engine 1. The blower 21 blows through vents (not shown) in the automobile. Inherently, the air conditioner 2 of automobile can operate in an internal circulation mode or an external circulation mode. The internal circulation mode means internal air of the automobile is continuously recycled to be cooled by the air conditioner without exchange of outside air. The external circulation mode means outside air enters the air conditioner to be cooled for replacing inside air.

A solar generator 3 is preferably mounted on the roof of the automobile for transducing solar power into electric power. The solar generator 3 electrically connects to the blower 21 for outputting electric power to the blower 21. A relay 4 is arranged between the solar generator 3 and the blower 21 for switching the electric power flow. The relay 4 is controlled by a controller 5. A thermosensor 6 is connected to the controller 5 for detecting inside temperature of the automobile. The controller 5 outputs a control signal to have the relay 4 switch on/off according to a comparison between a sensed inside temperature and a threshold temperature set by a user. The blower 21 is driven by the solar generator 3 when the relay 4 switches on. The controller 5 is capable of forcing the blower 21 into the external circulation mode. When the automobile is choked and inside temperature thereof rises above the threshold temperature, the controller 5 will control the relay 4 to switch on and simultaneously control the blower 21 to operate in external circulation mode, and then the blower 21 will work to suck outside air for making an air convection.

The blower 21 of the automobile can be sufficient to make an air convection between inside and outside the automobile, so the inside temperature of the automobile can be effectively reduced when the automobile is parked under the sun.

While the present invention has been described in terms of specific embodiment incorporating details to facilitate the understanding of the principles of construction and operation of the invention. As such, references, herein, to specific embodiment and details thereof are not intended to limit the scope of the claims appended hereto. It will be apparent to those skilled in the art that modifications can be made in the embodiment chosen for illustration without departing from the spirit and scope of the invention.

What is claimed is:

1. A solar powered ventilation system for an automobile driven by an engine, the automobile having an air conditioner composed of a blower and a compressor clutchedly driven by the engine, the ventilation system comprising:
a solar generator for transducing solar power into electric power, outputting the electric power to the blower;
a relay electrically connected between the solar generator and the blower for switching the electric power from the solar generator to the blower;
a controller electrically connected to the relay and the air conditioner, programmed to:
control the relay to switch on/off; and
control the air conditioner into an external circulation mode; and
a thermosensor electrically connected to the controller for detecting an inside temperature of the automobile, and sending an inside temperature signal to the controller;
wherein the controller controls the relay to switch on and controls the air conditioner into the external circulation mode when the automobile is choked and the inside temperature exceeds a threshold temperature.
